(19) United States
(12) Patent Application Publication
(10) Pub. No.: US 2012/0278334 A1
(43) Pub. Date: Nov. 1, 2012

(54) Database System

(76) Inventor: John Abjanic, San Diego, CA (US)

(21) Appl. No.: 13/458,793

(22) Filed: Apr. 27, 2012

Related U.S. Application Data
(60) Provisional application No. 61/518,057, filed on Apr. 29, 2011.

(51) Int. Cl. G06F 17/30

(52) U.S. Cl. 707/741; 707/E17.002; 707/E17.005

(57) ABSTRACT

A data structure. The data structure includes a record containing data, a record identifier associated with the record, a user identifier associated with the record, and a linking identifier containing the record identifier of a single record with which the linking identifier is associated and the user identifier associated with the record.

### CROSS-REFERENCE TO RELATED APPLICATIONS

This application claims the benefit under Title 35, United States Code §119(e), of U.S. Provisional Patent Application Ser. No. 61/518,057, filed Apr. 29, 2011 and entitled Data Model and Interface, which is hereby incorporated by referenced in its entirety.

### STATEMENT REGARDING FEDERALLY SPONSORED RESEARCH

Not applicable.

### FIELD OF THE INVENTION

The field of invention is related to the technical field of data models and, more particularly, to the field of data models and interfaces for computer systems.

### BACKGROUND OF THE INVENTION

There are problems with conventional graph data models and database systems that use the data models. Resource Description Framework (“RDF”) is a World Wide Web consortium (“W3C”) standard specification. RDF has been the W3C standard for encoding data since 1999. Data can be broken down into small pieces of information called triples, which have their own semantics and work much the same as a sentence that is broken down into a subject, predicate, and object. This information can then be manipulated using extensible markup language (“XML”). The main benefit of RDF is that data can be pulled from different databases and organized as needed by the user. The problem with RDF, however, is that it does not have a simple and clearly defined insert, update, or delete methods. The insert method does not provide a way to insert multiple properties in one method call. RDF uses the SPARQL query language, but is complex and difficult to understand and use.

Apache Cassandra has an insert method, but cannot insert multiple properties in one method call. Cassandra has no clearly defined and simple to use query language. Cassandra does not have the built-in capability to join or link multiple column families or tables.

RDF, Cassandra and other data models have their own application program interface (“API”), but do not have a standard XML web service interface or graphical user interface (“GUI”).

SQL has query language that is complex and difficult to use, It is also hard to integrate disparate SQL databases.

Consumer social media applications and social business applications use the notion of users posting information to a system in the form of short unstructured text messages (or tweets). This information has a limited data structure in the form of hashtags and URL web references or web page links that can be embedded anywhere in the body of the text. The problem with this type of information posting is that the data is hard for users to manage, retrieve, filter and analyze. There is just a very rudimentary capability to perform a simple textual sting comparison of keywords or hashtags and there is no contextual search mechanism.

Accordingly, it is believed that embodiments of the invention described herein can provide for an improved database structure.

### SUMMARY OF THE INVENTION

Embodiments of an improved database are disclosed. In accordance with a first embodiment of the database, a data structure is disclosed. The data structure includes a record containing data, a record identifier, which may be a subject, associated with the record, a user identifier, which may be a namespace, associated with the record, and a linking identifier, which may be a keyID, containing the record identifier of a single record with which the linking identifier is associated and the user identifier associated with the record. The database may also include a data model and that data model may be referenced in the linking identifier.

In a second embodiment of the database, a method of structuring data is provided. The method of structuring data includes a first computing device creating a record and inserting data in the record. The method of structuring data also includes transmitting the record and the data from the first computing device to an application server, the application server creating a record identifier associated with the record, creating a user identifier associated with the record, and creating a linking identifier containing the record identifier of a single record with which the linking identifier is associated and the user identifier associated with the record.

In another embodiment of the database, a method of structuring data includes creating a record using a first processor, inserting data in the record using the first processor, transmitting the record and the data from the first processor to a second processor, receiving at the first processor an indication that the second processor has created a record identifier associated with the record, receiving at the first processor an indication that the second processor has created a user identifier associated with the record, and receiving at the first processor an indication that the second processor has created a linking identifier containing the record identifier of a single record with which the linking identifier is associated and the user identifier associated with the record.

Accordingly, the present database provides solutions to the shortcomings of prior databases. Those of ordinary sill in the art will readily appreciate, therefore, that other details, features, and advantages will become further apparent in the following detailed description of the preferred embodiments.

### BRIEF DESCRIPTION OF THE DRAWINGS

The accompanying drawings, which are incorporated herein and constitute part of this specification, include one or more embodiments of the invention, and together with a general description given above and a detailed description given below, serve to disclose principles of the invention in accordance with a best mode contemplated for carrying out the invention.

FIG. 1 is a chart of database system including elements of data models, in accordance with an embodiment;

FIG. 2 illustrates examples of datamodels that may be used in a database system, in accordance with an embodiment;

FIG. 3 illustrates a database hardware system that may be used with database system embodiments, in accordance with an embodiment; and

FIG. 4 illustrates components that may be included in the database hardware system, in accordance with an embodiment.

### DETAILED DESCRIPTION

Reference will now be made to embodiments of the data model and interface, examples of which are illustrated in the accompanying drawings. Details, features, and advantages of the data model and interface will become further apparent in the following detailed description of embodiments thereof.

Any reference in the specification to “one embodiment,” “a certain embodiment,” or a similar reference to an embodiment is intended to indicate that a particular feature, structure, or characteristic described in connection with the embodiment is included in at least one embodiment of the invention. The appearances of such terms in various places in the specification are not necessarily all referring to the same embodiment. References to “or” are furthermore intended as inclusive so “or” may indicate one or the other ored terms or more than one ored term.

One embodiment of the system includes a base data model that uses elements or identifiers. The data model may be considered to be an extension or type of a graph data model. The data model can be used in a system, such as the global public World Wide Web, a global information grid, a web portal, a corporate intranet, an extranet, an embedded system such as a network router or cell-phone, or special purpose standalone computer. The data model may be schema-less, in that, in certain embodiments, all instances of the data models use the common structure as described by the following: the data model has a universal, common general purpose programmable interface and visual interface.

The system, in which the data model exists, may be created to have one or more of the following elements: a datamodel, namespace, subject, keyID, property, value, and timestamp, along with other additional elements if desired. A record is a collection of data that may be identified by the unique identifier of the system called the keyID. Each record may include data related to one or more of the following: one or more properties (e.g., first property 51, a second property 53, a third property 61, a fourth property 63, a fifth property 65, a sixth property 111, a seventh property 113, an eighth property 115, a ninth property 161, a tenth property 163, an eleventh property 191, and a twelfth property 193), one or more values (e.g., a first value 52, a second value 54, a third value 62, a fourth value 64, a fifth value 66, a sixth value 112, a seventh value 114, an eighth value 116, a ninth value 162, a tenth value 164, an eleventh value 192, and a twelfth value 194), and optionally one or more timestamps (e.g., a first timestamp 40, a second timestamp 80, a third timestamp 90, a fourth timestamp 150, and a fifth timestamp 180) associated with a keyID (e.g., first keyID 50, a second keyID 60, a third keyID 110, a fourth keyID 160, and a fifth keyID 190). There may be one datamodel, with one namespace and one subject associated with each keyID. One timestamp may also be associated with a keyID. A keyID can have zero or more properties associated with it, where each property has a property name and an associated value. The keyID can be a GUID e, a URL, or may use another identification scheme such as a unique number, alphanumeric string, or any other identification method.

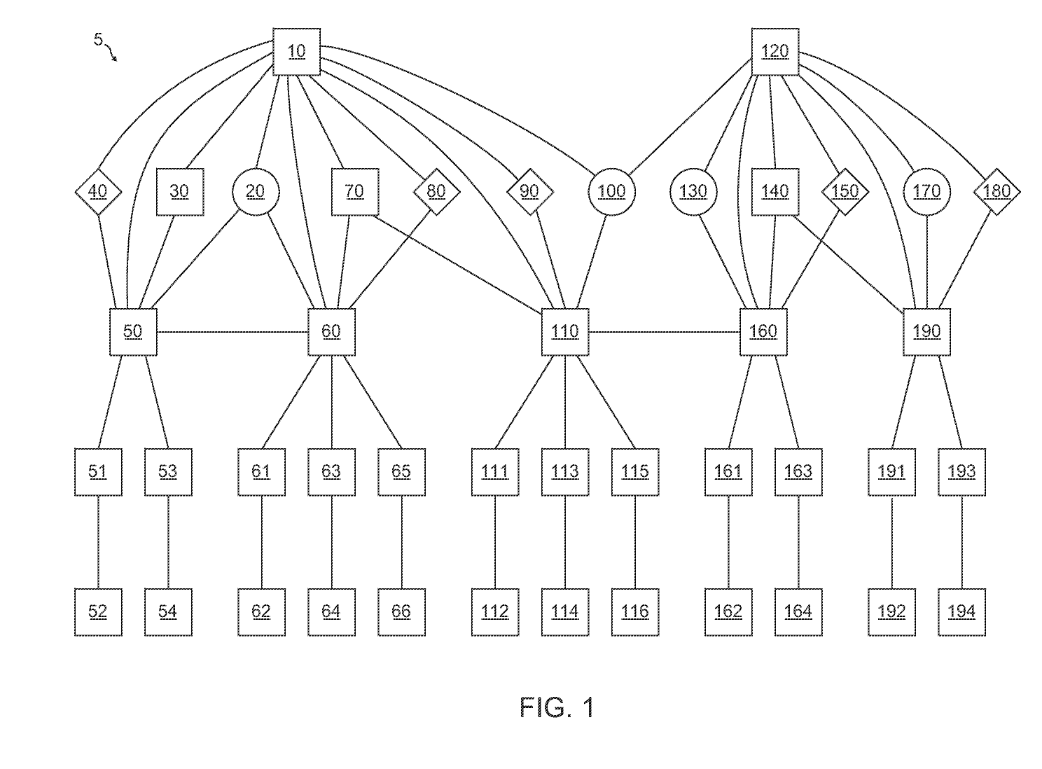

FIG. 1 illustrates a database system 5, in accordance with an embodiment of the present invention. The database system 5 includes a first datamodel 10 and a second datamodel 120; a first namespace 20, a second namespace 100, a third namespace 130, and a fourth namespace 170; a first subject 30 a second subject 70, and a third subject 140; a first keyID 50, a second keyID 60, a third keyID 110, a fourth keyID 160, and a fifth keyID 190; a first property 51, a second property 53, a third property 61, a fourth property 63, a fifth property 65, a sixth property 111, a sixth property 113, an eighth property 115, a ninth property 161, a tenth property 163, an eleventh property 191, and a twelfth property 193; a first value 52, a second value 54, a third value 62, a fourth value 64, a fifth value 66, a sixth value 112, a seventh value 114, an eighth value 116, a ninth value 162, a tenth value 164, an eleventh value 192, and a twelfth value 194; a first timestamp 40, a second timestamp 80, a third timestamp 90, a fourth timestamp 150, and a fifth timestamp 180.

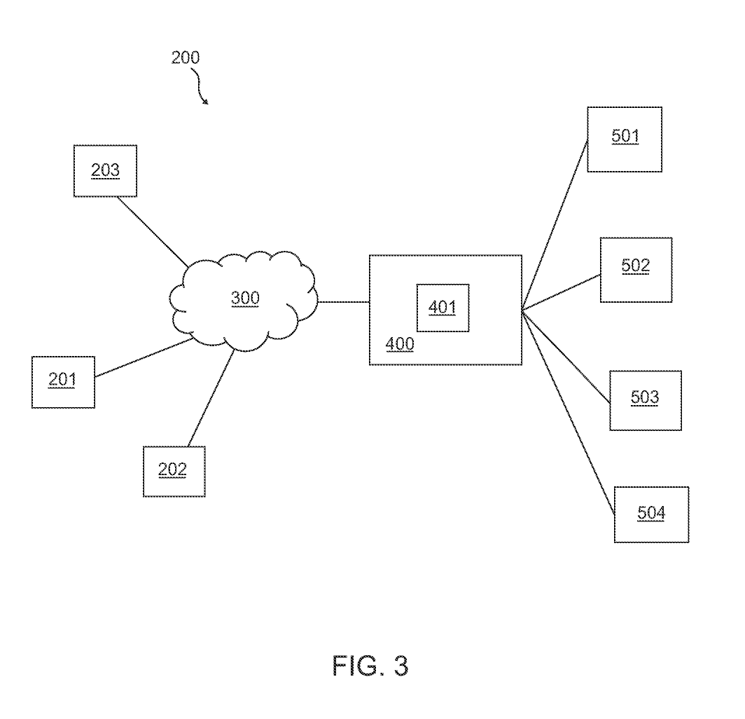

In that embodiment, a user, which may, for example, be a human operator or machine, is assigned the first namespace 20 by the database hardware system 200, which is described below with respect to FIG. 3, or another database hardware system. The first namespace 20 in this embodiment may also be referred to as a first namespace element 20. That user creates the first datamodel 10 by creating a first datamodel 10 into the database system 5. Creating may be accomplished by, for example, inserting or posting information to an element, such as the first datamodel 10.

The first namespace 20 or the user associated with the first namespace 20 also becomes the default administrator of first datamodel 10 automatically by operation of the database hardware system 200.

The user associated with the first namespace 20 in the embodiment of FIG. 1 next posts data to the first datamodel 10 by creating first subject 30 along with associated first property element 51 and its corresponding first value element 52 and associated second property element 53 with its corresponding second value element 54.

First keyID element 50 is automatically generated by the data engine 401 after the first subject 30, first property element 51, first value element 52, second property element 53, and second value element 54 are created. The keyID is a system unique identifier that identifies a record that is associated with 0 or more properties. The keyID typically has one or more property elements, such as first and second property elements 51 and 53, and one or more value elements, such as first and second value elements 52 and 54, that are associated with a datamodel, such as first datamodel 10, and also identifies a namespace, such as first namespace 20, and a subject, such as first subject 30. In the embodiment of FIG. 1, the record is identified by its associated first subject 30. In addition, in this embodiment the first keyID 50 and each other keyID 60, 110, 160, and 190 is associated with only one datamodel 10 or 120, only one namespace 20, 100, 130, or 170, and only one subject 30, 70, or 140.

A timestamp element 40 is provided in the embodiment of FIG. 1 to record the date and time of creation of the first subject 30, first property element 51, first value element 52, second property element 53, and second value element 54. The timestamp 40 is optional and may also be automatically generated by the data engine 401.

The user associated with namespace element 20 can post or insert data to the datamodel 10 by, for example as illustrated in FIG. 1, posting subject element 70 along with the associated property element 61 and its corresponding value element 62, the associated property element 63 with its corresponding value element 64, and associated property element 65 with its corresponding value element 66. KeyID element 60 may then be automatically generated by the data engine 401 200 to associate the record associated with subject 70, property elements 61, 63, and 65, and value elements 62, 64, and 66 with datamodel 10 and namespace 20.

Timestamp element 80 may be automatically generated by the data engine 401. For example, the data engine 401 may determine the time or date that data is posted and associate that time or date “timestamp” with the element in which the data is posted.

Namespace element 20 can link the records associated with subjects 30 and 70 in datamodel 10 by linking keyID 60 to keyID 50. By linking the keyIDs that are associated with a namespace, all data under the linked keyIDs may be available to each of those keyIDs and their associated namespaces. Accordingly, a search from a linked keyID or associated namespace can uncover data in or from all the records associated with the linked keyIDs,

The user associated with namespace element 20 can similarly insert namespace 100 to datamodel element 10, if desired.

A user can discover the existing data structure for subject element 70 and post data to the datamodel through namespace 100 by inserting data to existing subject element 70 along with the associated property element 111 with its corresponding value element 112, the associated property element 113 with corresponding value element 114, and the associated property element 115 with its corresponding value element 116. KeyID element 110 can be automatically generated by the data engine 401. Timestamp element 90 can also be automatically generated by the data engine 401.

A user can create a new datamodel through namespace 130 by creating datamodel element 120 and inserting data related to datamodel 120 into the system. Namespace element 130 becomes the default administrator of datamodel 120 when datamodel 120 is created through namespace 130. Namespace element 130 may also add namespace element 100 and namespace element 170 to datamodel element 120.

The user associated with namespace element 130 can post data to the datamodel by posting subject element 140 along with associated property element 161 and its corresponding value element 162 and associated property element 163 with its corresponding value element 164. KeyID element 160 may also be automatically generated by the data engine 401. Timestamp element 150 may also be automatically generated by the data engine 401.

A user can discover the existing data structure for subject element 140 by searching through namespace 170. The user can also post data to the datamodel 120, for example, by inserting data into existing subject element 140 along with associated property element 191 and its corresponding value element 192 and the associated property element 193 with its corresponding value element 194. KeyID element 190 may be automatically generated by the data engine 401. Timestamp element 180 may also be automatically generated by the data engine 401. Namespace element 100, in that example, may also link records in datamodels 10 and 120 by linking keyID element 160 to keyID element 110.

A user associated with a namespace 20, 100, 130, or 170 can also update data in one or more datamodels 10 or 120 that are associated with that namespace 20, 100, 130, or 170. For example, if a user associated with namespace 20 wants to make an update to datamodel 10, that user can use an interface in the database hardware system 200 to perform that update. In various embodiments, the interface may be a visual interface or a programmable interface that performs a locate function to locate records that have been posted through namespace 20. That interface may be included in a computer 201 or wireless device 202 as described below with respect to the database hardware system 200 and illustrated in FIG. 3, for example. The interface may include a program that is performed or executed by the computer 201 or wireless device 202. For example, the interface may be an application that runs on any computing device.

The data engine 401 can provide access through a namespace, such as namespace 20, to a user associated with that namespace. In that way, for example, a user associated with that namespace can have access to data in the database and various datamodels. In addition, by providing access to data through a namespace, access to data can be controlled by providing access to data only to a user who is associated with a namespace associated with the data.

In an example illustrated in FIG. 1, namespace element 20 locates keyID element 50 and updates value element 52 that corresponds to property element 51. Any namespace can do the same for properties or other values in other datamodels to which a user associated with the namespace has posted data. The data that are typically updated in a datamodel 10 and 120 may more frequently be value elements 52, 54, 62, 64, 66, 112, 114, 116, 162, 164, 192, and 194 than property elements 51, 53, 61, 63, 65, 111, 113, 115, 161, 163, 191, and 193, subject elements 30, 70, and 140, or datamodel elements 10 and 120 since property elements 51, 53, 61, 63, 65, 111, 113, 115, 161, 163, 191, and 193, subject elements 30, 70, and 140, and datamodel elements 10 and 120 may be used as names to define or describe the value elements 52, 54, 62, 64, 66, 112, 114, 116, 162, 164, 192, and 194 and those names may not require updating as regularly as value elements 52, 54, 62, 64, 66, 112, 114, 116, 162, 164, 192, and 194, which may be, for example, a number of parts held in stock.

Namespace users can perform searches or queries to retrieve data in datamodels with which their namespaces are associated, in certain embodiments. Those users may, for example, query for all the data that has been posted by all the namespaces associated with a particular datamodel 10 and 120.

For example, a namespace element 20 user may use a visual interface or programmable interface to initiate a search or query on datamodel element 10. Namespace element 20 may then choose to filter the search or query by subject element 70 to receive all the data 61, 62, 63, 64, 65, and 66 associated with that subject 70. Namespace element 20 may choose an additional filter to filter by property element 111equal to value element 112, for example. The system may then determine that the matching keyID for this query is keyID element 110. The data engine 401 may then return a result of: value element 112 for property element 111, value element 114 for property element 113, and value element 116 for property element 115. Data engine 401 may also return a reference to the data linked to keyID 160.

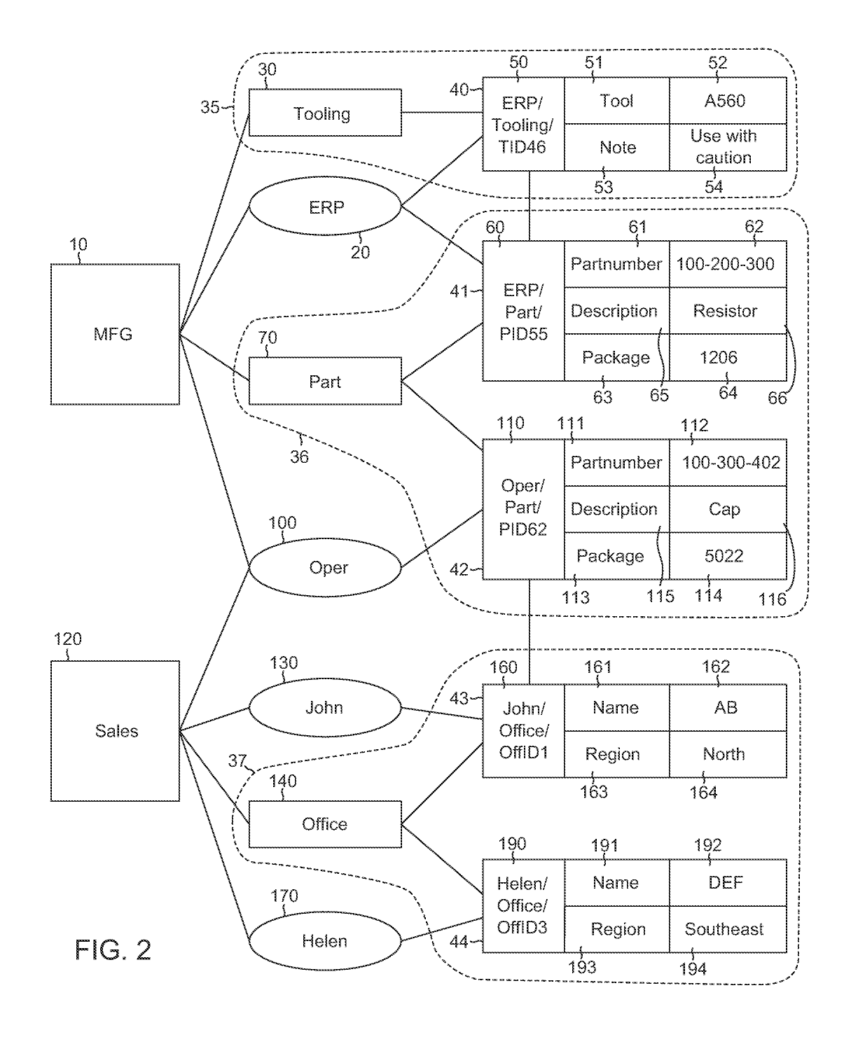

FIG. 2 illustrates an embodiment of a database system that includes examples of datamodels 10 and 120 containing tables 35-37, which contain records 40-44 and have associated subjects 30, 70, and 140. The records contain data elements that include sample properties 51, 53, 61, 63, 65, 111, 113, 115, 161, 163, 191, and 193, and sample values 52, 54, 62, 64, 66, 112, 114, 116, 162, 164, 192, and 194, and have associated key IDs 50, 60, 110, 160, and 190. A namespace 20, 100, 130, and 170 is furthermore associated with each key ID.

Datamodels 10 and 120 may identify data in one or more tables 35-37 contained in those datamodels. For example, each datamodel 10 and 120 may be or include a name associated with data contained within that datamodel 10 and 120, such as the names of products with which the data in the datamodels are associated, or departments such as manufacturing (“MFG”) and sales (“Sales”).

Tables 35-37 may include subjects 30, 70, and 140 that identify data contained in those tables 35-37. For example, subjects 30, 70, and 140 may be or include names associated with data contained in tables 35-37, such as “part,” “tooling,” and “office.”

As introduced above, tables 35-37 may also include one or more records 40-44. Records 40-44 may furthermore have keyIDs 50, 60, 110, 160, and 190 associated therewith. The keyIDs 50, 60, 110, 160, and 190 may furthermore reference subjects 30, 70, and 140, and namespaces 20, 100, 130, and 170 associated with records 40-44. Alternately, the keyID can reference other elements, such as, for example, subjects 30, 70, and 140 and datamodels 10 and 120. Such reference may be formed in any way known in the database arts, including using pointers to subjects 30, 70, and 140 and namespaces 20, 100, 130 and 170 associated with the records so, for example, any change made in tables 35-37 or namespaces 20, 100, 130, and 170 will be reflected in the keyIDs.

Namespaces 20, 100, 130, and 170 may be considered a control layer. A namespace may exist for a datum or a data group, such as, for example, a keyID, record, or data element in a record, and may, for example, identify the person, department, or machine that entered that data element. In an embodiment wherein a human user enters any of properties 51, 53, 61, 63, 65, 111, 113, 115, 161, 163, 191, or 193, with values 52, 54, 62, 64, 66, 112, 114, 116, 162, 164, 192, or 194, the namespace associated with those properties, values, or the associated keyIDs 50, 60, 110, 160, and 190 may record an identification of the user, such as, for example, one or more of the name of the user, the initials of the user, the department in which the user works, and any other information that identifies where the data element originated. In another example, a data element may be entered by a machine, such as a computer, and that computer may have a name associated with it, such as, for example, “ERP” for a computer that performs enterprise resource planning functions. In such an embodiment where such a machine enters the data element, the namespace associated with that data element may be assigned “ERP” or one or more other pieces of identifying information.

The present database system, embodiments and parts thereof which are depicted in FIGS. 1 and 2, may operate in a database hardware system 200 that is standalone or integrated and can exchange data to and from two or more database hardware systems (e.g., like 200 or other database hardware systems) via the programmable interface. The database system may be used for web 2.0 or 3.0, or in applications such as social networking, blogging or business mashups, may group results of collaboration on a project or assignment, may enterprise applications such as ERP=CAD-CAE, SCM, PLM, BI, data warehouse, bioinformatics, medical informatics, may perform defense applications such as C2, C3, C4, ISR, C4ISR, and M2M. The present database system may be used with wireless networks, healthcare applications, industrial applications, utility applications, transportation applications, and many other types of systems and applications. The present database can be used with extensions to computer operating systems and cloud computing services. Furthermore, the present invention may be packaged and used in a data engine (in memory or disk-based), a data engine embedded in an application on one computer, a data engine in a server shell wrapped around a conventional database system such as RDF, Apache Cassandra, or a SQL database, a conventional 3-tier web architecture, network equipment- routers, switches, modem, gateways, and persistent systems or non-persistent systems.

FIG. 3 is a graphic illustration of a database hardware system 200 that may be utilized with the database embodiments described herein, such as the database system 5. In the database hardware system 200, a web service can execute an XML programmable interface and can be used to retrieve data from various disparate data bases, such as datamodels 10 and 120. The programmable interface can be used by human or non-human clients of the web service. Non-human clients may include, for example, computers and computer programs that are authorized to retrieve data from datamodels 10 and 120. A computer 201, such as a personal computer or laptop computer, may perform the web service and may use a web browser to query and view data in datamodels 10 and 120. The web browser may be HTML based or any other software or system. A wireless device 202, such as a smartphone or tablet, may similarly perform the web service and may use a web browser to query and view data in datamodels 10 and 120. The wireless device may also use HTML and may be any device desired, including a device native windowing system, such as an iPhone or iPad that uses Apple ios, or a device that uses an Android operating system. A nonhuman associated client 203, such as a computer or computer program, which may include, for example, a web service programmable interface to exchange data with the database system 5, may also perform the web service. Any device that can query and view data in datamodels 10 and 120 can be used in the database hardware system 200.

A network 300, which may be a public network, such as the Internet or World Wide Web, or a private enterprise intranet or extranet is illustrated in the database hardware system 200 and may be used to link user devices 201 and 202 to a machine operating a database that stores datamodels 10 and 120. FIG. 3 also illustrates a conventional web or application server 400, operating a data engine 401, a first database 501 for storing datamodels 10 and 120, a second database 502 for storing datamodels 10 and 120, a third database 503 for storing datamodels 10 and 120, and a fourth database 504 for storing datamodels 10 and 120. It should be recognized that the databases can be of any type desired and can operate using SQL, RDF, Cassandra, or memory or disk-based storage, for example.

When implementing embodiments of the database hardware system 200, one or more back end databases could be selected to store datamodels 10 and 120. A conventional three-tier web architecture can be used to implement the datamodels 10 and 120. In one embodiment of such a three-tier architecture, there is a client tier, a middle tier, which can include a web server or an application server, for example, and a back end database tier.

In such an embodiment, the clients could be PCs, wireless devices, or other systems. For PC or wireless devices, a user may interface with the database hardware system 200 using a web browser. HTML code may be used to render the display for the user interface. The user may construct a search or query via the user interface and the web browser may convert or transform each search or query presented in HTML to XML formatted data. If one or more clients are non-human systems, searches or queries may be constructed in XML formatted data. In embodiments, clients send the XML formatted data embedded in a message to the middle tier, via the internet networking infrastructure. The middle tier's web or application server receives that message and sends instructions to the data engine, which converts or transforms the XML formatted data embedded in the message into a native database query and sends that database query to a backend data base.

Where a shell is used, the shell may be a combination of the web or application server and a data engine, which works in conjunction with the web or application server.

In embodiments, the datamodels 10 and 120 are stored in a back end database. The backend data base could be a relational data base (e.g., SQL) or a graph database (e.g., RDF or Cassandra). In embodiments in which the backend database is a SQL database, the XML formatted data may be converted or transformed to a SQL formatted query, processed by the SQL database, and the query result may be returned as XML formatted data and sent back to the client, via the middle tier. In embodiments in which the client is a PC or wireless device the XML formatted data may be converted or transformed to HTML and displayed on the web browser's screen for the user to view. In embodiments in which the datamodels 10 and 120 are stored in an RDF database, XML formatted data can be converted or transformed to SPARQL formatted query or another desired format.

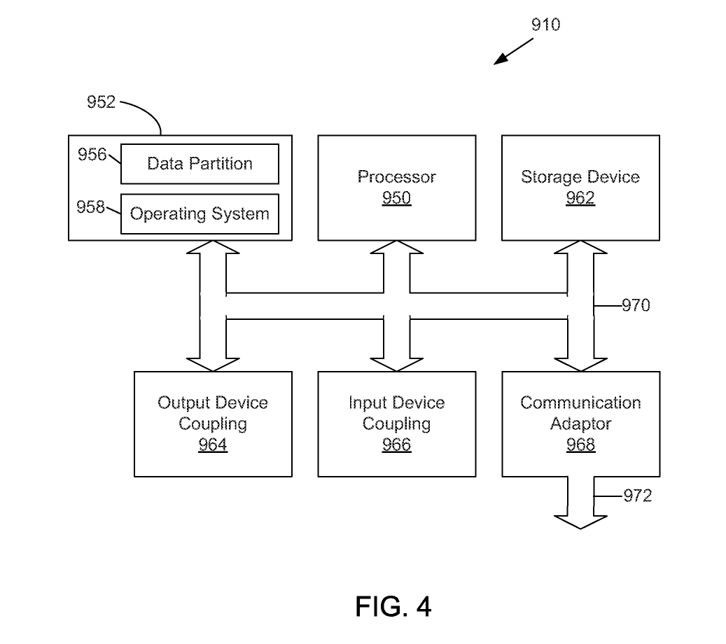

As shown in FIG. 4, components 910 that may be included in the database hardware system 200 if desired, including in the user devices 201 and 202 and the web or application server 400, may include a processor 950, memory 952, a storage device 962, a coupling for an output device 964, a coupling for an input device 966, and a communication adaptor 968. Communication between the processor 950, the storage device 962, the output device coupling 964, the input device coupling 966, and the communication adaptor 968 is accomplished by way of one or more communication busses 970. It should be recognized that components of the database hardware system 200 may have fewer, more, or other components than shown in FIG. 4. For example, if a user interface is not desired, the input device coupling 966 or output device coupling 964 may not be included with one or more components of the database hardware system 200.

The memory 952 may, for example, include random access memory (RAM), dynamic RAM, and/or read only memory (ROM) (e.g., programmable ROM, erasable programmable ROM, or electronically erasable programmable ROM) and may store computer program instructions and information. The memory 952 may furthermore be partitioned into sections including an operating system partition 158 where system operating instructions are stored, and a data partition 956 in which data is stored.

The processor 950 may, for example, be an Intel® type processor or another processor manufactured by, for example AMD®, DEC®, or Oracle®. The processor 950 may furthermore execute the program instructions and process the data stored in the memory 952. In one embodiment, the instructions are stored in memory 952 in a compressed and/or encrypted format. As used herein the phrase, “executed by a processor” is intended to encompass instructions stored in a compressed and/or encrypted format, as well as instructions that may be compiled or installed by an installer before being executed by the processor 950.

The storage device 962 may, for example, be non-volatile battery backed SRAM, a magnetic disk (e.g., hard drive), optical disk (e.g., CD-ROM) or any other device or signal that can store digital information. The communication adaptor 968 permits communication between the computer 910 and other devices or nodes coupled to the communication adaptor 968 at the communication adaptor port 972. The communication adaptor 968 may be a network interface that transfers information from a node such as a general purpose computer to the control circuitry 910 or from the control circuitry 910 to a node. It will be recognized that the control circuitry 910 may alternately or in addition be coupled directly to one or more other devices through one or more input/output adaptors (not shown).

The input device coupling 966 and output device coupling 964 may couple one or more input or output devices. It will be recognized, however, that the computer does not necessarily need to have an input device or an output device to operate. Moreover, the storage device 962 may also not be necessary for operation of the computer 910 as data may be stored in memory, for example.

The elements 950, 952, 962, 964, 966, and 968 related to the components 910 may communicate by way of one or more communication busses 970. Those busses 970 may include, for example, a system bus or a peripheral component interface bus.

Various ways to use the datamodel instances 10 and 120 include, for example, using those datamodel instances 10 and 120 for just unstructured text, just structured data, combinations of structured and unstructured text, single subjects or tables with no joins or links, or for multiple subjects or tables with joins or links. The datamodel instances 10 and 120 may be used for unstructured text with structured data, single records, or multiple records, for example.

A common, universal and general purpose programmable and XML interface can be used to build client application and can be used to build visual interfaces such as a GUI or a CLI. The GUI could be used in web browser or another kind of windowing system, such as Xwindows, Microsoft Windows, and Apple Windows such as an iMac, iPhone, or iPad. The interface can have basic CRUD-like capabilities. Datamodel instances 10 and 120 can be derived from a core abstract datamodel that has the datamodel, namespace, subject, keyID, property, and value elements or identifiers.

A user associated with a namespace 20, 100, 130, or 170 can create a new datamodel 10 or 120 instance. When a user associated with a namespace 20, 100, 130, or 170 creates a new datamodel 10 or 120, the namespace 20, 100, 130, or 170 can become the administrator of the datamodel 10 or 120. The datamodes administrator can then add one or more other namespaces 20, 100, 130, or 170 in the database system 5 to be part of the datamodel 10 or 120. A user associated with a namespace 20, 100, 130, or 170 associated with the datamodel 10 or 120 can create a new subject and create one or more associated of new properties 51, 53, 61, 63, 65, 111, 113, 115, 161, 163, 191, and 193 and insert values 52, 54, 62, 64, 66, 112, 114, 116, 162, 164, 192, and 194 to the datamodel 10 or 120 in embodiments. A user associated with a namespace 20, 100, 130, or 170 can make changes to the content it has created in embodiments. The administrator of a datamodel namespace 20, 100, 130, or 170 may be permitted to update the name of the datamodel or delete the datamodel. Administrators of other namespaces 20, 100, 130, or 170 associated with a datamodel 10 or 120 may be permitted to update or delete subject names, property names, and property values. The combination of a datamodel 10 or 120 and a subject 30, 70, or 140 can become a data channel to which an administrator or a user associated with a namespace 20, 100, 130, or 170 can post or insert data content. When a user associated with a namespace 20, 100, 130, or 170 inserts content to the data channel, other namespaces 20, 100, 130, or 170 that are in the datamodel 10 or 120 can discover those new subjects and properties or values that are in the subject. The subjects and properties of subjects can serve as guides for a user associated with a namespace 20, 100, 130, or 170 to insert or post content that can then be shared with all the namespaces 20, 100, 130, or 170 in a datamodel 10 or 120.

For example, there could be a datamodel called acme and namespaces called Ted.Jackson, Rose.Jones and Helen.Smith. Ted.Jackson may create a subject that is called ProjectXYZ:status and insert content that creates unstructured text and structured data properties for the subject. Other namespaces that are part of the acme datamodel, such as Rose.Jones and Helen.Smith can discover that there now exists a Project:XYZ:status subject with certain properties and can insert or post additional content to the subject. Rose.Jones can also insert another property to the subject and other namespaces in the acme datamodel could then discover the new property inserted by RoseJones.

Embodiments of the database system 5 can include a basic query language that is used to get content from datamodels. Those embodiments may include methods to retrieve content that matches data for the elements in a datamodel 10 and 120. Those embodiments may also include operators in the form of equal, greater than, and less than, for example. Queries in those embodiments can be constructed that are contextual based on structured data. For example, a getContent method could retrieve data where propertyA=valueB, or where propertyE=valueF and propertyG=valueH, or where propertyR<valueT and so on.

In certain embodiments, there is the capability to match on wildcards* so that if a client application or GUI user wants to retrieve all data for subject=project*, the result would have the data for subject project:ABC, project:DEF, projectXWZ, etc. Another example would be to retrieve all data where property=Partnumber and value=100-200*. Partnumbers such as 100-200-300 and 100 [symbol] 200-888 could also be retrieved. In certain embodiments, there is a capability to use the interface to make scripts, and procedures with or without variables. For example, when a client application or GUI user wants to retrieve Partnumber data where the Partnumber is a variable, a procedure could use a variable operator and the client application or GUI user would then input the appropriate information to get the desired result.

Embodiments of the database system, such as database system 5, may be able to perform data mapping to and from other system database formats. For example, the present invention may map to an RDF in the following ways. In one embodiment, the database system may have the following tuples of data elements: (datamodel, namespace, subject, timestamp, keyID, property and value). The RDF tuples of data elements may be (subject, predicate, object). The following are some of the possible ways the database system could be mapped.

One RDF tuple may have its subject have the database system's keyID element's value, the predicate have the value of “datamodel,” and the object have the database system's datamodel value.

There may next be an RDF tuple, for which the RDF's subject has a database system's keyID element's value, the predicate has the value of “namespace,” and the object has the database system's namespace value.

Next, there may be an RDF tuple, for which the subject has the database system's keyID element's value, the predicate has the value of “subject,” and the object has the database system's subject value.

There could be an RDF tuple in which the RDF's subject has the database system's keyID value, the predicate has the value of “timestamp,” and the object has the database system's timestamp value.

There could also be additional RDF tuples for each property-value pair that is present in the database system's record. In such a data mapping, the RDF's subject could have the database system's keyID element value, the predicate could have the database system's property name, and the object could have the database system's property value.

The present invention may also be able to map to an SQL database. One way in which the database system could be mapped to the SQL is to have the database system's tuples map to attributes, such as fields or columns, in a logical SQL table.

In one embodiment, there may be a SQL table record for each property in a database system's record. For example, the SQL table datamodel attribute may have the database system's datamodel element's value, the SQL table namespace attribute may have the database system's namespace element's value, the SQL table subject attribute may have the database system's subject element's value, and so on through all the tuples of the database system.

The present invention may also be able to map to an NoSQL database such as Cassandra. One way in which the database system could be mapped to Cassandra is to have the database system's records of data make sets of Caddandra tuples: (keyspace, column family name, column family key, column name, column value, column timestamp).

One way of mapping has Cassandra's tuple's keyspace having the database system's datamodel element value, the column family name having the database system's subject element's value, the column family key having the database system's KeyID element's value, the column name being the value of “namespace,” the column value being the database system's namespace value, and the column timestamp being the database system's timestamp value.

There may be additional Cassandra tuples for each property-value pair in a present database system's record. For example, for each property of the database system, Cassandra tuple's keyspace may have the database system's datamodel element's value, the column family may have the database system's subject element's value, the column family key may have the database system's keyID element's value, the column name may have database system's property's name, the column value may have the database system's property's value, and the column timestamp may be the database system's timestamp value.

Other database types, such as SQL, may be converted into a database system herein, such as the database system 5. In one conversion of an SQL to the database system, the datamodel element may be the SQL database name, the namespace element may be the SQL database name, the subject element may be the SQL table name, and the timestamp element may be the point in time when the SQL data is converted. In this conversion, the keyID element may take the form of (SQL database name/table name/primary key attribute name/primary key attribute value). For example, such a keyID may be in the form (ERP/Part/PartID/1).

In the instance in which SQL table attributes are not foreign keys linked to another table's primary key, the database system property element may be the SQL attribute name and the corresponding database system value element may be the SQL attribute value. If the SQL table attributes are foreign keys linked to another table's primary key, the database system property element may be the foreign key's table name and the corresponding database system value element may be in the form of (SQL database name/foreign table name/key attribute name/key attribute value). For example, such the value element may take the form (ERP/Supplier/SupplierID2).

For the data models of RDF and Cassandra, there may be, in an embodiment, no logical transformation or conversion to datamodel. As a result, there may be no mapping conversion from RDF or Cassandra to the inventive database system.

Functionality the database system 5 may have is the ability to post a single record in a single datamodel. One example of the use of the database system is the updating of the system throughout the lifecycle of a project. It may be expected that at various points in time during a project lifecycle, member namespaces will update status and post data. In one such example, a manager for a project may setup a datamodel named “work group” with associated namespaces of “John,” “Ted,” and “Rose.” The manager may also create a subject called “Status:Project:ABC” having the properties of “Product,” “Module,” and “Comment.” Upon each namespace updating and entering that namespace's data, the database system may appear like the following in an embodiment:

Subject: Status:Project:ABC

| Namespace | Product | Module | Comment |
|---|---|---|---|
| John | prod1 | 1.0 | Fixed software bug 123 |
| Ted | prod2 | 2.2 | Met with hardware engineering to |
| | | | discuss integration |
| Rose | prod1 | 1.5 | Next generation concept reviewed and |
| | | | approved |

In example of posting a single record in a single datamodel, a namespace, “AcmeCompany,” is a manufacturer of widgets. That company may have multiple supply chain partners that are used to supply specific parts for the widgets. The Subject “Part” may have the following properties, “Partnumber” and “Quantity.” Namespaces “Supplier1,” “Supplier2,” and “Supplier3” may be added to the database (group) called “AcmeSupplyChain.” As parts are ordered, delivered, and used by “AcmeCompany,” and as suppliers supply parts to other companies, each supplier's inventory is constantly changing. Namespace “Helen” who works for “AcmeCompany” may be assigned to monitor the supply chain. She may perform on demand searches/queries at various periods to monitor and manage the supply chain. As a result, the namespace Helen can view the data and/or an application program that may be programmatically monitoring the supply chain, which may automatically trigger an action based on the supplier quantities of a specific part. One example query result is as follows:

Subject: Part

| Namespace | Partnumber | Quantity |
|---|---|---|
| Supplier1 | 100-200-300 | 140 |
| Supplier2 | 100-200-300 | 560 |
| Supplier3 | 100-200-300 | 75 |

A third example of posting a single record in a single datamodel is a case in which a power company needs to monitor various physical parameters in a power grid. The namespaces associated with this datamodel may check the status of the grid. The following is an example of a search/query result.

Subject: Electrical power grid DEF

| Namespace | Volt | Amps | Temperature |
|---|---|---|---|
| Sensor1 | 110 | 5 | 89 |
| Sensor2 | 105 | 10 | 95 |
| Sensor3 | 115 | 8 | 102 |

Another functionality of the system database 5 may be to post a table with multiple records in a single database. A namespace named “StockServiceXYZ” may have a stock quote service and may want to publish or post data either on a public datamodel (group) global web or a private group of subscribers. The service posts data to a subject named “Stockquotes,” which may have properties entitled, “Symbol,” Price,” and “Change.” There may be thousands of stocks, and each stock may have specific detailed structured data. The namespaces that are in the group for this stock service may perform searches/queries to get the data for the stocks. The following is an example of a search/query result.

Namespace: StockServiceXYZ
Subject: Stockquotes

| Symbol | Price | Change |
|---|---|---|
| sym1 | 28.14 | +0.15 |
| sym2 | 14.15 | −0.56 |
| sym3 | 124.34 | +1.25 |

A second example of posting a table with multiple records to a single database is a case in which a namespace, “John,” has created a datamodel (group) with a specific property named “Rating” in addition to a default “Comment” property. The database system may be setup where any namespace in the group can search/query for individual stocks such as search for Symbol=“sym1” and in turn post their data. The following is an example of a search/query result.

Namespace: StockServiceXYZ
Subject: Stockquotes

| Symbol | Price | Change |
|---|---|---|
| sym1 | 28.14 | +0.15 |

| Namespace | Rating | Comment |
|---|---|---|
| John | A | I think this stock is undervalued. |
| Helen | C | They are coming out with a new product in Q3. |
| Maria | B | Fairly valued prices should be 31. |

The database system may also have the functionality of being able to post records to multiple databases and perform integration. In one example, there various disparate relational databases exist in a system. A typical system may be a company or enterprise and its intranet or an extranet and includes the company's or enterprise's various partners or customers. In this example, the databases are “ERP,” “Operations,” and “Engineering”. The data from these databases may reside externally relative to the infrastructure of the database resources of the database system 5 in an embodiment. The programmable interface of the database system 5 may be used to retrieve data from each of these databases by having the database invoke a direct SQL table conversion and/or or by the database generating a tabular SQL query result. This output data may then be inserted into the present invention's datamodel(s). The concept of a namespace may not exist in the relational datamodel, so after extraction, the namespace element in the present invention's datamodel may be the same or default to the source database name. The following chart describes more details of example data after the extraction. Label “DM” refers to the database or the present invention datamodel. Label “NS” refers to the namespace. Label “Oper” refers to “Operations” and label “Engr” refers to “Engineering”.

| DM | NS | Subject | KeyID | Property | Value |
|---|---|---|---|---|---|
| ERP | ERP | Part | ERP/Part/PartID55 | Partnumber | 100-200-300 |
| ERP | ERP | Part | ERP/Part/PartID55 | Description | Resistor |
| Oper | Oper | Workcenter | Oper/Workcenter/WctrID2 | Station | 320 |
| Oper | Oper | Workcenter | Oper/Workcenter/WctrID2 | Description | Auto pick and place |
| Engr | Engr | Tooling | Engr/Tooling/ToolingID46 | Tool | A560 |
| Engr | Engr | Tooling | Engr/Tooling/ToolingID46 | Note | Use caution when |
| | | | | | install this part |

Namespace “John” is a knowledge worker in the enterprise. He creates a new datamodel named “Manufacturing”. As the creator, the datamodel “John” is the administrator of the datamodel. This datamodel is an application database and data may be integrated or mashed together for the application. He adds namespaces “ERP,” “Engineering,” and “Operations” to the datamodel. A process is started in which data is transferred from the source datamodels to the destination “Manufacturing” datamodel. Namespace “ERP” inserts records for the “Part” subject extracted from the “ERP” datamodel. Namespace “Operations” inserts records for the “Workstation” subject extracted from the “Operations” datamodel and Namespace “Engineering” inserts records for the “Tooling” subject extracted from the “Engineering” datamodel.

The various namespaces in the application datamodel “Manufacturing” can link or join specific records to each other. For example, namespace “ERP” can take a specific “Part” record and insert a property named “Workcenter” with a directed link to a specific record belonging to a “Workcenter” subject. In addition, “ERP” can take the “Part” record and can also insert a property named “Tooling” with a link to a specific record belonging to a “Tooling” subject. These links can be uni-directional such as a specific “Part” record directed to a specific “Workcenter” record or also bi-directional with the specific “Workcenter” record directed back to the specific “Part” record. The following chart describes more details of an example linkage. Label “MFG” refers to the “Manufacturing” datamodel.

| DM | NS | Subject | KeyID | Property | Value |
|---|---|---|---|---|---|
| MFG | ERP | Part | ERP/Part/PartID55 | Partnumber | 100-200-300 |
| MFG | ERP | Part | ERP/Part/PartID55 | Description | Resistor |
| MFG | ERP | Part | ERP/Part/PartID55 | Workcenter | Oper/Workcenter/WctrID2 |
| MFG | ERP | Part | ERP/Part/PartID55 | Tooling | Engr/Tooling/ToolingID46 |
| MFG | Oper | Workcenter | Oper/Workcenter/WctrID2 | Station | 320 |
| MFG | Oper | Workcenter | Oper/Workcenter/WctrID2 | Description | Auto pick and place |
| MFG | Engr | Tooling | Engr/Tooling/ToolingID46 | Tool | A560 |
| MFG | Engr | Tooling | Engr/Tooling/ToolingID46 | Note | Use caution when |
| | | | | | installing this part |

The following is a simplified view a user might see via the visual or graphical user interface used in embodiments after all the links have been made:

| Subject | Partnumber | Description |
|---|---|---|
| Part | 100-200-300 | Resistor |

| Subject | Station | Description |
|---|---|---|
| Workcenter | 320 | Auto pick and place |

| Subject | Tool | Note |
|---|---|---|
| Tooling | A560 | Use caution when install this part |

As the administrator of the “MFG” datamodel, namespace “John” adds namespace “Ted” and namespace “Rose” as group members of the datamodel. Any namespace member can insert new subjects, properties, and values to the datamodel, depending on their privileges. For example, “Ted” adds the properties, “Package” and “Pin,” to the “Part” subject and specifically for record referenced by keyID “ERP/Part/PartID55” adds value “1206” for property “Package” and value “2” to property “Pin.” In addition, “Helen” adds a new subject, “Supplier,” to the datamodel and defines specific properties, creates records, and adds values.

| DM | NS | Subject | KeyID | Property | Value |
|---|---|---|---|---|---|
| MFG | ERP | Part | ERP/Part/PartID55 | Partnumber | 100-200-300 |
| MFG | ERP | Part | ERP/Part/PartID55 | Description | Resistor |
| MFG | Ted | Part | ERP/Part/PartID55 | Package | 1206 |
| MFG | Ted | Part | ERP/Part/PartID55 | Pin | 2 |
| MFG | ERP | Part | ERP/Part/PartID55 | Workcenter | Oper/Workcenter/WctrID2 |
| MFG | ERP | Part | ERP/Part/PartID55 | Tooling | Engr/Tooling/ToolingID46 |
| MFG | Oper | Workcenter | Oper/Workcenter/WctrID2 | Station | 320 |
| MFG | Oper | Workcenter | Oper/Workcenter/WctrID2 | Description | Auto pick and place |
| MFG | Engr | Tooling | Engr/Tooling/ToolingID46 | Tool | A560 |
| MFG | Engr | Tooling | Engr/Tooling/ToolingID46 | Note | Use caution when install |
| | | | | | this part |
| MFG | Helen | Supplier | Helen/Supplier/SupplierID3 | Name | supplierDEF |
| MFG | Helen | Supplier | Helen/Supplier/SupplierID3 | Region | North |

Each namespace may control access to the records the namespace has created or owns. When a source data record is updated by a namespace, such as when namespace “ERP” changes the property, “Partnumber,” value from “100-200-300” to “100-200-301,” the change gets propagated to each record throughout the applicable datamodels that have the system unique keyID, “ERP/Part/PartID55.”

The database system 5 may also have the functionality to convert data from a relational database into a datamodel such as described herein. In this example, data may come from a relational database, as either a raw table structure data or a tabular SQL querty result set. However, data could come from other data sources that are not in a relational database, such as XML files, text flat files, etc. that may have to use the the programmable interface in embodiments. The default namespace for the converted database maybe the same as the database name. The following is an example of a converted relational database into the database system 5.

Source relational data:
Database: ERP
Table: Part

| PartID | Partnumber | Description | Package | Pin | SupplierID |
|---|---|---|---|---|---|
| 1 | 100-200-300 | Resistor | 1206 | 2 | 2 |
| 2 | 100-222-333 | Capacitor | 805 | 2 | 1 |
| 3 | 234-123-456 | CPU chip | PLCC | 128 | 2 |

Table: Supplier

| SupplierID | Name | Region |
|---|---|---|
| 1 | Acme | West |
| 2 | Foo | East |

Converted data into datamodel:

| KeyID | Property | Value |
|---|---|---|
| ERP/Part/PartID1 | Partnumber | 100-200-300 |
| ERP/Part/PartID1 | Description | Resistor |
| ERP/Part/PartID1 | Package | 1206 |
| ERP/Part/PartID1 | Pin | 2 |
| ERP/Part/PartID1 | Supplier | :ERP/Supplier/SupplierID2 |
| ERP/Supplier/SupplierID2 | Name | Acme |
| ERP/Supplier/SupplierID2 | Region | West |
| ERP/Part/PartID2 | Partnumber | 100-222-333 |
| ERP/Part/PartID2 | Description | Capacitor |
| ERP/Part/PartID2 | Package | 805 |
| ERP/Part/PartID2 | Pin | 2 |
| ERP/Part/PartID2 | Supplier | ERP/Supplier/SupplierID1 |
| ERP/Supplier/SupplierID1 | Name | Foo |
| ERP/Supplier/SupplierID1 | Region | East |
| ERP/Part/PartID3 | Partnumber | 234-123-456 |
| ERP/Part/PartID3 | Description | CPU chip |
| ERP/Part/PartID3 | Package | PLCC |
| ERP/Part/PartID3 | Pin | 128 |
| ERP/Part/PartID3 | Supplier | ERP/Supplier/SupplierID2 |

| KeyID | Datamodel | Subject | Namespace |
|---|---|---|---|
| ERP/Part/PartID1 | ERP | Part | ERP |
| ERP/Part/PartID2 | ERP | Part | ERP |
| ERP/Part/PartID3 | ERP | Part | ERP |
| ERP/Supplier/SupplierID | ERP | Supplier | ERP |
| ERP/Supplier/SupplierID2 | ERP | Supplier | ERP |

Embodiments of the interface may also have the capability to issue one or more result codes for methods, such as 1 for a successful procedure and 0 for an unsuccessful procedure and may also provide an error code to explain why the method was unsuccessful.

The following are various functions the interface may be capable of performing in embodiments, and various means it can use to perform those functions.

For the login method of one embodiment, a user or client application initially logs into the system. Once the user or client application is logged in, a getDataModels (namespace) can be used by the user or client application to connect to a specific datamodel. The user or client application can login just once to get access to all its datamodels. The user or client application can then enter the user's or client application's name value for the namespace prompt and password for the password prompt and the resultcode will return a 1 for successful login or 0 for unsuccessful login. The logout method prompts the user to enter the value for the namespace element of the logout function and the resultcode will return a 1 for successful logout or 0 for unsuccessful logout.

The createDataModel function of one embodiment creates a new datamodel for the database system 5, which can be performed by the system administrator or datamodel administrator. Each namespace has its own default datamodel name equal to the namespace. As a result, the datamodel name will be unique in the database system 5. The user will enter a value for the DataModel prompt and a name value for the namespace prompt and the resultcode will return a 1 for successful Datamodel creation or 0 for unsuccessful Datamodel creation.

The createNamespace function of one embodiment allows the system administrator to add namespaces to the database system 5. A new user can also request that the system administrator join the database system 5. In doing so, the user will enter a value for the Namespace prompt and the resultcode will return a 1 for successful creation of a new namespace creation or 0 for unsuccessful creation of a new namespace.

The getDataModels function of certain embodiments will return a list of DataModels associated with a namespace 20, 100, 130, or 170. This function will typically be used to present a list of DataModels to which a user may “connect.” The user may then enter a value for the Namespace prompt and the GetDataModelsResult will return all DataModels associated with the NameSpace value. An alternative way to list all DataModels is to leave an unassigned value to the NameSpace prompt, thereby returning a result of every DataModel.

The getNameSpaces function of certain embodiments returns a list of NameSpaces association with a DataModel. This function may be used to see a list of all namespaces 20, 100, 130, or 170 in a group. The datamodel and namespaces returned in the result set can be used to navigate the insertContent (DataModel, namespace, subject, properties) function or one of the various getContent functions to perform queries. In operation, the user can enter a value for the DataModel prompt and the GetNameSpacesResult will return all NameSpaces associated with the DataModel value. An alternative way to list all NameSpaces is to leave an unassigned value to the DataModel prompt, thereby returning a result of every NameSpace in the system.

The assocNamespaceToDataModel function of certain embodiments allows the administrator for a DataModel to assign a NameSpace to the DataModel. To do so, the user will enter a value for the DataModel prompt and a value for the NameSpace prompt and the resultcode will return a 1 for successful association of a NameSpace with a DataModel or 0 for unsuccessful association of a NameSpace with a DataModel.

The insertContent function of certain embodiments inserts a record with multiple properties. A keyID feature may automatically assign a keyID to the DataModel, NameSpace, Subject, and Properties when this function is used. If a property value that is entered is not in the template structure for this DataModel-Subject, then the property value is automatically created and put into the result. A timestamp may also be applied to the record. Any namespace associated with the datamodel can insert content to the datamodel. The user will enter a value for the DataModel, NameSpace, Subject, and Property Name(s) and a keyID will be assigned to the record that will be created.

An alternative for the insertContent function is to insert one property in an existing record. This is typically used to add content to an existing record. A timestamp can be applied to the record for the keyID. The database system 5 may have the capability to differentiate such that a user associated with a namespace that had originally inserted content for a record is able to insert a property into an existing record. The database system 5 may have the capability that any user associated with any namespace in the datamodel be able to insert a property into an existing record if that user or namespace is permitted that privilege. To insert a property into an existing record, the user may enter a value for the NameSpace, keyID, Property name and value and the resultcode will return a 1 if the insertion of the property is successful or 0 if the insertion of the property is not successful.

The getContent function of certain embodiments retrieves all content for the matching parameters for a single subject(table) and for one property-value combination in the record associated with the subject. The function can use the keyID in the result set to navigate to: insertContent(keyId, property, value) or updateValue(keyId, property, oldValue, newValue), or deleteContent(keyId). The user can enter a value for each of the DataModel, NamesSpace, Subject, Property, and Value and the GetContentResult will list the keyID, Property Name(s), and associated Timestamp.

An alternative to the getContent function is included in certain embodiments for situations in which there is only one subject value (single table) in a datamodel, such as datamodel 10 or 120. In that instance, the function may return just specific properties which may use the keyID in the result to navigate to: insertContent(keyId, property, value) or updateValue(keyId, property, oldValue, newValue), or deleteContent(keyId). To use this function, the user can enter a value for the Properties, NameSpace, and Subject and the GetContentResult will list multiple keyIDs, with the associated DataModel, property values, and timestamps associated with each keyID.

An alternative to the getContent function is a function that uses the query language capability to get all properties. In such a function, the query capability can use a keyID in the result set to navigate to: insertContent(keyId, property, value) or updateValue(keyId, property, oldValue, newValue), or deleteContent(keyId). The user can enter a value for the DateModel, NameSpace, Subject, and Query Parameters prompts at either of those functions, and the GetContentResult can list the keyID, Property Name(s), and Timestamp corresponding to the prompts.

Another alternative embodiment of the getContent function uses the query language capability to get properties which can use a keyID in the result set to navigate to: insertContent(keyId, property, value) or updateValue(keyId, property, oldValue, newValue), or deleteContent(keyId). The user can enter a value for the Properties, DataModel, NameSpace, Subject, and Query Parameters prompts of those functions, and the GetContentResult can list the keyID, Property Name(s), and Timestamp corresponding to the prompts.

The getContentForKeyID function, which is used in some embodiments, uses the data in the result set to navigate to: insertContent(keyId, property, value) or updateValue(keyId, property, oldValue, newValue), or deleteContent(keyId). To use this function, the user can enter a value at the keyID prompt, and the GetContentForKeyIDResult will list the DataModel, NameSpace, Subject, Property Name(s), and Timestamp associated with that keyID.

The getContentForSubject function of certain embodiments allows a user or client application to use the keyId for further processing to getContentForKeyID, update, delete, etc. Furthermore, the user can use the keyID in the result set to navigate to: insertContent(keyId, property, value) or updateValue(keyId, property, oldValue, newValue), or deleteContent(keyId). To use this function, the user can enter a value for the DataModel and Subject prompts, and the GetContentForSubjectResult will list the keyID(s) and the NameSpace, Property Name(s), and Timestamp associated with that keyID.

An alternative for the getContentForSubject function is to use only one specific NameSpace for the Subject to have a finer grained search. The user can use the keyID in the result set to navigate to: insertContent(keyId, property, value) or updateValue(keyId, property, oldValue, newValue), or deleteContent(keyId). To use that function, the user can enter a value for the DataModel, NameSpace, and Subject prompts, and the GetContentForSubjectResult will list the keyID(s) and the Property Name(s) and Timestamp associated with that keyID.

The database system 5 may include the getContentForNamespace function. The getContentForNamespace returns all content for a specific namespace, can use the keyID in the result set to navigate to: getContentForSubject(String dataModel, String namespace, String subject) or insertContent(keyId, property, value), updateValue(keyId, property, oldValue, newValue), or deleteContent(keyId). The user can enter values for the DataModel and the Namespace and the GetContentForNameSpaceResult will return the corresponding keyID's along with the corresponding subjects, propertys, values, and timestamps.

In one embodiment, the database system 5 includes a GetSubjects function. The Get Subjects function is a coarse-grained search, that returns a list of subjects that have been inserted for a datamodel by all the namespaces, a user or client app can drill down using Subject in the result set to navigate to: getContentForSubject(String dataModel, String subject) or use the Subject in one of the getContent methods. The user can enter a value for the DataModel and the GetSubjectsResult can list all the subjects in the datamodel.

Another function the database system 5 may include is a function to getProperties. The getProperties function returns a list of properties that have been used for the subject in a datamodel. The result set can be used by users or client applications to discover the properties that have already been used for the subject. The function can be used for insertContent methods, insertContent(dataModel, namespace, subject, properties) or insertContent(keyId, property, value). The user can enter a value for the DataModel and Subject elements and the GetPropertiesResult will list all the properties that correspond with the datamodel and subject entered.

Another function that may exist in one embodiment is the UpdateDataModel function. In an embodiment, this function can only be performed by the datamodel's administrator namespace. All the content associated with the old datamodel can now be associated to the new datamodel. A timestamp is applied to the datamodel. The user can enter a value for the NameSpace, OldDataModel, and NewDataModel prompts and the ResultCode will return a 1 for successful update or 0 for not successful update.

One embodiment may contain an UpdateSubject function that updates the subject name for a datamodel and for all its content. The system has the capability that only the namespace that created the subject within the datamodel can perform this function. In that case, the old subject name may still exist in the datamodel and still be associated for content associated with the other namespaces in the datamodel. The system has another capability to let any namespace in the datamodel update the subject depending on the subject's privileges. In this case, the subject name can be changed for all the content in the datamodel. A timestamp may be applied to the subject. The user can enter a value for the DataModel, Namespace, OldSubject, and NewSubject prompts and the ResultCode will return a 1 for successful update or 0 for unsuccessful update.

One embodiment may contain an UpdateValue function which updates a property's value for a datamodel. The system has the capability that only the namespace that had inserted the content within the datamodel can perform this function. The system has another capability that any namespace for the datamodel can update the value for the keyID depending on the namespace's privileges. A timestamp can be applied to the record for the KeyID. The user may enter a value for the Namespace, KeyID, Property, OldValue, and NewValue prompts and the ResultCode will return a 1 for successful update or 0 for unsuccessful update.

One embodiment may contain an UpdateProperty function that changes the property name for a subject and its associated content in a datamodel. The system has the capability that only the namespace that had inserted the property within the datamodel can perform this function. In that case, the old property name may still exist in the datamodel and still be associated for content associated to other namespace in the datamodel. The system has another capability that allows any namespace for the datamodel to update the property depending on namespace's privileges. In that case, the property name may be updated for the content for all namespaces in the datamodel. A timestamp can be applied to the record for the keyID that is associated to the property. The user can enter a value for the DataModel, Namespace, Subject, OldProperty, and NewProeprty prompts and the ResultCode will return a 1 for successful update or 0 for unsuccessful update.

One embodiment may contain a DeleteDataModel function which deletes the datamodel from the system and all content for the datamodel. This can only be done by the administrator namespace that created the datamodel. The user may enter a value for the DataModel, and Namespace prompts and the ResultCode will return a 1 for successful deletion or 0 for not successful deletion.

One embodiment may contain a DeleteNamespace function that deletes the namespace from the system and all the content associated with the namespace, and may only be able to be done by the sysadmin. The user may enter a value for the Namespace prompt and the ResultCode will return a 1 for successful deletion or 0 for unsuccessful deletion.

One embodiment may contain a DeleteNamespaceAssocWithDataModel function that deletes namespace and all its content associated with a data model, and may only be able to be done by sysadmin or the datamodel administrator's namespace. The user may enter a value for the DataModel and Namespace prompts and the ResultCode will return a 1 for successful deletion or 0 for unsuccessful deletion.

One embodiment may contain a DeleteSubject function that deletes the subject and all content for the subject in a datamodel. The system has the capability that this can only be performed by the namespace in the datamodel that had inserted it. In that case, the old subject name may still exist in the datamodel and still be associated for content associated to other namespaces. The system has another capability that allows any namespace within the datamodel to delete the subject, depending on the namespace's privileges. In that case, the subjects for all namespaces in the datamodel may be deleted. The user may enter a value for the DataModel, Namespace, and Subject prompts and the ResultCode will return a 1 for successful deletion or 0 for unsuccessful deletion.

One embodiment may contain a DeleteProperty function that may just delete content for one property. The system has the capability that this can only be performed by the namespace in the datamodel that had inserted it. In this case, the old property name may still exist for the subject in the datamodel and still be associated with content associated with other namespaces. The system has another capability that any namespace in the datamodel can delete a property, depending on the datamodel's privileges. In that case the property name and its associated content will be deleted for all subjects for all namespaces in the datamodel. The user may enter a value for the DataModel, Namespace, Subject, and Property prompts and the ResultCode will return a 1 for successful deletion or 0 for unsuccessful deletion.

One embodiment may contain a DeleteContent function that deletes all content just for one record associated with a keyID. The system has the capability that this can only be performed by the namespace in the datamodel that had inserted the content. The system has another capability that any namespace in the datamodel can delete the content, depending on the datamodel's privileges. The user may enter a value for the DataModel, Namespace, and keyID prompts and the ResultCode will return a 1 for successful deletion or 0 for unsuccessful deletion.

It should be understood that the naming conventions that provide the structure for the set and subset structure of the new model disclosed herein might have alternative names without changing the structure of the new model. For example, some might call the “datamodel” element, the “database,” “domain” or “group” element, someone might call the “subject” element a “topic,” or a “ table,” someone might call a “property” element a “field,” etc.

The following terms and specifications are referenced in this document.

World wide web (WWW)

World wide web consortium (W3C)

Extensible Markup Language (XML)

Resource Description Framework (RDF)

SPARQL Query Language for RDF

Uniform Resource Locator (URL)

Application Programming Interface (API)

Structured Query Language (SQL)

Machine to Machine (M2M)

Enterprise Resource Planning (ERP)

Supply Chain Management (SCM)

Product Lifecycle Management (PLM)

Business Intelligence (BI)

Computer Aided Design (CAD)

Computer Aided Engineering (CAE)

Command and Control (C2)

Command, Control, Communications (C3)

Command, Control, Communications, Computers (C4)

Intelligence, Surveillance, Reconnasaince (ISR)

Graphical User Interface (GUI)

Command Line Interface (CLI)

Create, Retrieve, Update, Delete (CRUD)

Hyper Text Markup Language (HTML)

Global Unique Identifier (GUID)

While specific embodiments of the invention have been described in detail, it should be appreciated by those skilled in the art that various modifications and alternations could be developed in light of the overall teachings of the disclosure. Accordingly, the particular arrangements, apparatuses, systems, and methods disclosed are meant to be illustrative only and not limiting as to the scope of the invention.

What is claimed is:

1. A data structure, comprising:
a record containing data;
a record identifier associated with the record;
a user identifier associated with the record; and
a linking identifier containing the record identifier of a single record with which the linking identifier is associated and the user identifier associated with the record.

2. The data structure of claim 1, wherein the record contains at least one property and a value associated with the at least one property.

3. The data structure of claim 1, wherein the record contains a subject and does not contain a property.

4. The data structure of claim 1, wherein the record identifier is a subject and the subject identifies at least one of an apparatus and a function with which the record data is associated.

5. The data structure of claim 1, wherein a linking identifier is linked to a second linking identifier.

6. The data structure of claim 1, wherein the user identifier includes a namespace.

7. The data structure of claim 1, wherein the user is at least one of a human, a machine, and a workgroup.

8. The data structure of claim 1, wherein the data structure includes instructions contained in memory, wherein the instructions are executed by a processor, and wherein the record, the record data, the record identifier, the user identifier, and the linking identifier are stored in at least one data storage device.

9. The data structure of claim 8, further comprising instructions that cause the processor to automatically create the linking identifier.

10. The data structure of claim 8, further comprising instructions that cause the processor to automatically create the user identifier.

11. The data structure of claim 1, wherein the linking identifier further contains a database identifier that identifies a database in which the record resides.

12. The data structure of claim 1, wherein the linking identifier includes a keyID.

13. The data structure of claim 1, wherein one or more user identifiers are associated with the record and the data in the record is accessible only by the one or more users identified in the one or more user identifiers.

14. The data structure of claim 1, wherein one or more user identifiers are associated with the record and the data in the record is modifyable only by the one or more users identified in the one or more user identifiers.

15. The data structure of claim 14, wherein the data modification includes at least one of changing data in the record, adding data to the record, and removing data from the record.

16. The data structure of claim 1, wherein one or more user identifiers are associated with the record and the data in the record is searchable by the one or more users identified in the one or more user identifiers and one or more additional users identified in a user identifier of a record that is linked to the record.

17. The data structure of claim 1, wherein the user identifier identifies a user that created the record.

18. A method of structuring data, comprising:
a first computing device creating a record;
the first computing device inserting data in the record;
transmitting the record and the data from the first computing device to an application server;
the application server creating a record identifier associated with the record;
the application server creating a user identifier associated with the record; and
the application server creating a linking identifier containing the record identifier of a single record with which the linking identifier is associated and the user identifier associated with the record.

19. The data structure of claim 18, wherein the record is created by at least one of a human, a machine, and a workgroup and the record identifier, user identifier, and linking identifier are created by a database program.

20. A method of structuring data, comprising:
creating a record using a first processor;
inserting data in the record using the first processor;
transmitting the record and the data from the first processor to a second processor;
receiving at the first processor an indication that the second processor has created a record identifier associated with the record;
receiving at the first processor an indication that the second processor has created a user identifier associated with the record; and
receiving at the first processor an indication that the second processor has created a linking identifier containing the record identifier of a single record with which the linking identifier is associated and the user identifier associated with the record.
